(19) United States
(12) Patent Application Publication
(10) Pub. No.: US 2003/0055514 A1
(43) Pub. Date: Mar. 20, 2003

(54) Method to build a control system based on control cells

(76) Inventors: Antonio Mugica, Boca Raton, FL (US); Carlos Alonso, Caracas (VE); Roger Pinate, Caracas (VE); Paul Babic, Caracas (VE)

Correspondence Address: JEFFREY FURR, 253 N. MAIN STREET, JOHNSTOWN, OH, 43031, US

(21) Appl. No.: 09/682,067

(22) Filed: Sep. 17, 2001

(51) Int. Cl. G05B 11/01

(52) U.S. Cl. 700/19; 700/20

(57) ABSTRACT

The present invention relates to a method to implement any control system based on the logical association of identical single control devices (called control cells). Control cells are versatile control devices with basic processing capabilities that can be dynamically programmed and configured to perform any simple task. Control cells may be combined to form logical control device associations (called control tissues), which are complex control structures capable of carrying out complex tasks. This method of control system design and implementation has several outstanding advantages over the usual manner in which control systems are designed, including a significant reduction of both system complexity and system production/maintenance costs.

### BACKGROUND OF THE INVENTION

This invention relates to control methods and systems, specifically to a method to implement any control system, regardless of complexity, based on a structure comprising interconnected identical control devices.

### SUMMARY OF THE INVENTION

The present invention relates to a method to implement any control system based on the logical association of identical single control devices (called control cells). Control cells are versatile control devices with basic processing capabilities that can be dynamically programmed and configured to perform any simple task. Control cells may be combined to form logical control device associations (called control tissues), which are complex control structures capable of carrying out complex tasks. This method of control system design and implementation has several outstanding advantages over the usual manner in which control systems are designed, including a significant reduction of both system complexity and system production/maintenance costs.

### OBJECTS AND ADVANTAGES OF THE INVENTION

Accordingly, several objects and advantages of the present invention are:

a) To provide a novel method to implement a control system which can carry out any control task, regardless of complexity;

b) To provide said method which, due to its extraordinary simplicity, significantly reduces design, implementation, production and maintenance costs;

c) To provide said method consisting of a structure of basic control devices interconnected across a network;

d) To provide said method in which said interconnected control devices are physically identical;

e) To provide said method in which said devices are dynamically configurable to operate as control units and perform a specific task or process;

f) To provide said method in which said devices may logically associate in control device groups, thus forming complex control units that may conjunctly carry out a specific complex task more efficiently.

Other objects and advantages of this invention will become apparent from a consideration of the ensuing description and drawings.

### BRIEF DESCRIPTION OF DRAWINGS

FIG. 1 illustrates the physical implementation appearance of the preferred embodiment of the present invention.

FIG. 2 illustrates the same as FIG. 1, in which a series of control tissues have been formed by logically associated control cells.

### LIST OF REFERENCE NUMERALS

10, 12 Single control cells.

20 Control tissue formed through local connection of two control cells.

22 Control tissue formed through network connection of two control cells.

24 Control tissue formed through network connection of three control cells.

26, 28 Single control cells.

30 Control organ formed through connection of two control tissues and several single control cells.

### DETAILED DESCRIPTION

The present invention discloses a novel method to implement a control system that can be used to control any type of task or process where control is needed, regardless of its complexity. This task, called the main task, is such that it may be subdivided into simpler subtasks so that fulfillment of the simpler subtasks implies fulfillment of the main task.

Said control system, in the preferred embodiment, physically comprises one network constituted by several interconnected network nodes. This network may operate according to any existing network communication protocol and use any existing communication medium.

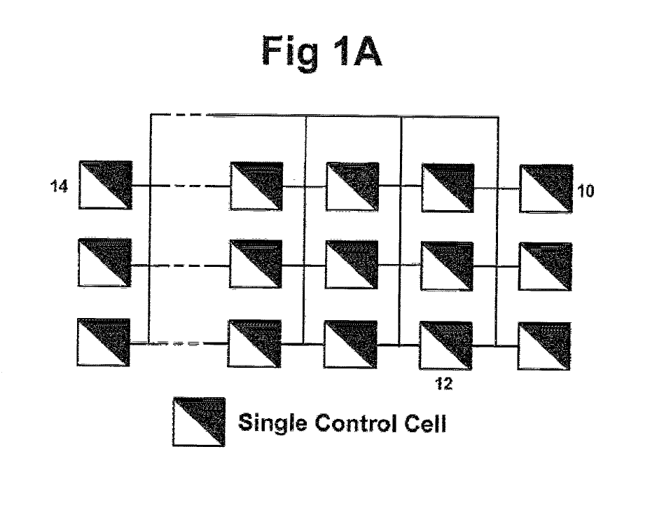

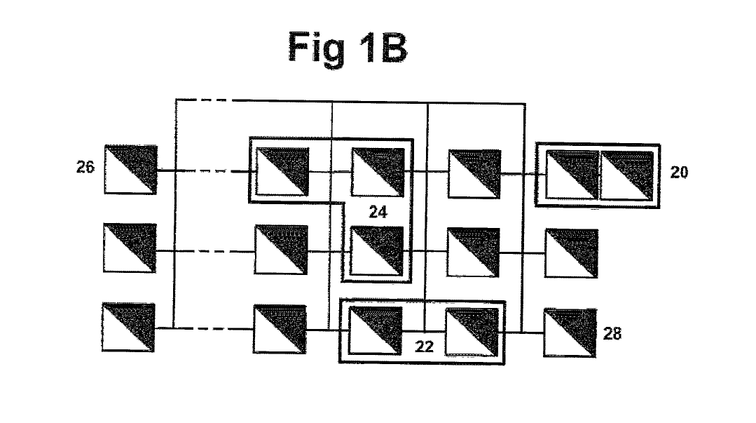

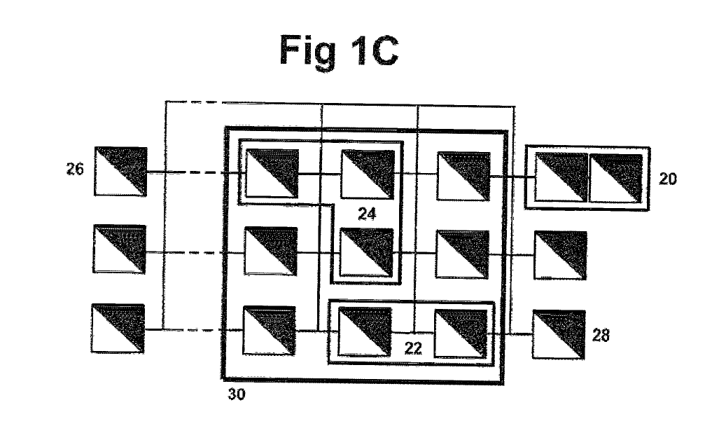

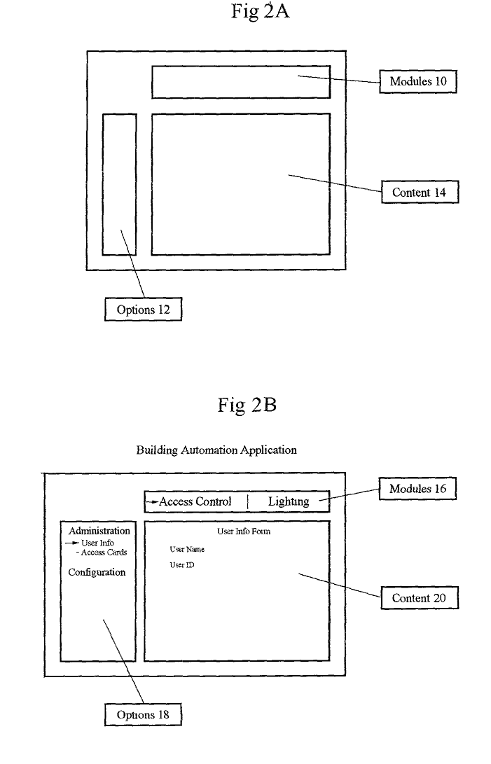

FIG. 1A illustrates an exemplary network layout for the present invention. Several network nodes are connected so that there is a direct connection between any two network nodes. In addition, network nodes do not necessarily reside physically together, that is, node 10 and node 14 may reside a thousand kilometers away from each other.

All network nodes are basic control devices with basic intelligence, and having several special properties. The following are all features of control devices:—All devices fit one same physical description. That is, all devices are physically identical.—All devices connect to one another through the underlying network.—All devices are interconnected, i.e., a signal may freely travel between any two devices, regardless of which two devices.—Each device may be configured to perform specific operations. That is, it can be programmed to handle a task. As any two physically identical devices are programmed differently, they may act differently to perform two different tasks. This results in logically differentiable devices.—All devices may openly communicate among them to exchange information and issue control commands, as necessary. Since all devices are physically identical, the method of establishing physical relationships between any two or more devices is the same.—Any two or more devices may constitute logical groups among themselves to collaborate in the fulfillment of one same subtask. Next, each of these features is described in detail.

Each device, called a control cell, comprises a processing unit (e.g., a processor where number crunching and logical operations may take place), a memory unit (e.g., where an application program and configuration attributes may be stored) and a communication unit (e.g., a module used for network communications), among others. Its internal operation is determined by the capabilities of its processing unit and by a program that is dynamically transferred into its memory unit from the outside. Said program describes the task that the control cell executes. Control cells comprising different programs result in logically differentiable cells carrying out different processes. Although the underlying hardware devices are identical, differently programmed cells are said to be of different cell types.

The advantages resulting from exclusively employing devices of one same kind and make to design and build an entire control system are remarkable.

First, there are several advantages to production. Since all control cells are physically identical, a production line for an entire control system solution requires production of one same piece of hardware replicated as many times as necessary, resulting in extraordinary production simplicity and cost reduction.

Second, there are several advantages to system assembling, since control cells can intrinsically connect with one another. They can be connected directly to each other, or through an underlying network system.

Third, there are several advantages in system configuration, programming and application creation. Every control cell is programmed using the same methods and tools, involving only one type of application programming language, without need to design and maintain program applications for several different control devices. At the same time, two different control cell types, performing two different tasks, can be produced by transferring two different programs and configuration settings into the respective memories of two physically identical control cells.

Fourth, there are several advantages in system maintenance. Any control cell may be swiftly replaced by any another control cell. The new cell may not even need reprogramming or reconfiguration.

Fifth, there are several advantages to system upgrading and expansion. Whenever expansion is necessary, control cells may be dynamically reprogrammed. Also, given the absolute degree of connectability between cells and the fact that cells can work together as a logical group to fulfill a task, more control cells may be added to the system to increase its processing power (see below).The communication module residing in each control cell ensures that a signal may travel across any existing type of network from one cell to another, using any existing communications protocol and medium. That is, communication between control cells may occur regardless of the underlying network implementation. Since all control cells are physically identical, the physical connection between any two of them is also identical.

The advantage of effortless interconnectivity is that a control system may be implemented over an existing network without having to incur in unnecessary expenses to implement a brand new control network. In addition, if implementation of a dedicated control network is desired, designers may opt for the network type that best suits project needs and budget (i.e., to minimize cost, to maximize speed and bandwidth, etc). The most important feature of the present method is that any two or more control cells may transparently assemble to constitute a logical cluster of cells, called control tissue. Since all control cells are physically identical, the operations required to generate control tissue are effortless, and are already built into the cells. “Glue” logic, a common source of errors, complexity and expense, is not necessary. Control cells can unite to form control issues by directly connecting to each other (through a serial port, or other), or by communicating across a network.

The main attribute of control tissue is unity. To an observer, control tissue performs as an inseparable control unit, comparable to a control cell. Since several control cells may be transparently gathered to form control tissue, control tissue implies higher processing power and more available control resources than offered by a single cell. Hence, it can perform tasks of higher complexity more efficiently.

The fundamental arrangement pattern of control tissue is that in which all member cells are programmed in the same fashion, namely, homogeneous control tissue. Cells that join to generate homogeneous control tissue are not only physically identical, but also identically programmed and configured (i.e., all member cells are equivalent).There are several arrangement variations in the formation of control tissue. Hybrid control tissue is generated when control cells of different configuration characteristics bind. Compound control tissue (also called control organ) is generated when two or more types of control units (e.g., control cells and/or control tissues) join to form a very complex control unit.

FIGS. 1B illustrates exemplary cases of control tissue formation. In FIG. 1B, control tissue 20 is formed by directly connecting two control cells (through a serial port, or other). Control tissue 22 is formed by two single control cells communicating over the network. Control tissue 24 is formed by three single control cells communicating over the network. Control cells need not reside next to each other networkwise to be able to form control tissue. In fact, control cell 26 and 28, residing geographically far from each other, may readily form a control tissue.

FIG. 1C illustrates an exemplary case of control organ formation. Control organ 30 is formed by logically associating control tissues 22 and 24, and four other single control cells. If desired, single cells 26 and 28 may also be integrated into control organ 30.There are outstanding advantages to the generation of control tissue.

In the simplest case, equivalent control cells may form homogeneous control tissue to share their control resources (i.e., processing power, input and output ports, among others). Combining the processing capabilities of several control cells, the resulting tissue performs the task faster and more efficiently. Since the association of control cells occurs at a logical level, very complex control system structures can be transparently formed to fulfill highly complex tasks. The resulting control tissue performs the task as if it were a single operating control unit.

An extraordinary advantage of this method relates to production and deployment of products. A simple control system may be produced by programming and configuring a single control cell. To produce a control system that performs the same task at a higher speed or a doubly difficult task at the same speed, two single control cells may be interconnected to perform it. The combination of control cells efficiently handles the task.

In addition, the present method allows control systems and its components to transcend geographical location. For instance, several control cells or tissues that partake in a control system may physically reside at different geographical locations. Yet, by means of network communication control cells may communicate among each other and maintain the unity attribute of control tissues and organs.

In addition, there are outstanding advantages related to system maintenance and expansion. Whenever a complex system must be expanded to process a higher level of input or to meet an incremental required throughput, it is only necessary to add control cells of the required type to each corresponding control tissue. The performance of each control tissue increases in direct relation to how many new control cells it receives. If new system functionality is required, new control tissue must be generated out of new control cells that are programmed and configured according to new functionality specifications. The new control cells then transparently incorporate into the existing system.

### Conclusion, Ramifications, and Scope of the Invention

Thus, the reader will see that the present method can be used to implement any type of control system based on the creation of a structure of single control cells. These control cells are versatile control devices that are physically identical.

Their versatility lies in that different types of cells can be generated by programming and configuring each control cell according to specific requirements, and thus cells of different types may perform different tasks. In addition, they are versatile because all cells can communicate with each other and interrelate over any type of network. The present method's most significant contribution is the construction of a control system, regardless of complexity, from several control devices of a single type (called control cell). The operation of the control system derives from logical associations between control cells (called control tissues). This results in outstanding reductions of cost in system production, maintenance, expansion and upgrade, due to its increased simplicity. Production of a control system is simplified to plugging together as many single cells as necessary, and programming and configuring each cell accordingly. System upgraded is simplified to plugging in, programming and configuring new control cells.

While our above description contains many specificities, these should not be construed as limitations to the scope of the invention, but rather as an exemplification of one preferred embodiment thereof. Obviously, modifications and alterations will occur to others upon a reading and understanding of this specification. For example, there are an infinite number of variations to the described logical associations between control cells (e.g., control tissues, control organs, etc). Also, a control system may comprise several networks interconnected by network routers, in which control cells residing in disparate networks may communicate to transparently form control tissue, organs, etc. Also, since control cells can directly connect to each other (as in FIG. 1B, control tissues 20), a control system may be implemented by a control tissue based on several directly interconnected control cells, which eliminates the need for a network altogether.

The description above is intended, however, to include all such modifications and alterations insofar as they come within the scope of the appended claims or the equivalents thereof.

What is claimed is:

1. A control system comprising: A plurality of network nodes; A data connection means between said network nodes; Said network nodes are physically identical and comprising of a processing means, a memory means and a communication means; Said network nodes are interconnected; Said network nodes can be configured for specific operations; and A plurality of network nodes may collaborate in the fulfillment a task.

2. A control system in claim 1 further comprising a plurality of network nodes working in unison to form a complex control unit.

3. A control system in claim 1 further comprising said network nodes can communicate across said network forming, at a logic level, controllers of complexity higher with said composite controllers perform like said network node.

4. A method for to implement any control system, regardless of complexity, based on a structure comprising interconnected identical control devices, the method comprising the steps of: Having a plurality of network nodes; Communicating through a data connection means between said network nodes; Having said network nodes being physically identical and comprising of a processing means, a memory means and a communication means; Having said network nodes interconnected; Configuring said network nodes for specific operations; and Having the capability a plurality of network nodes collaborating in the fulfillment a task.

5. The method in claim 4 further comprising having a plurality of network nodes working in unison to form a complex control unit.

6. The method in claim 4 further comprising said network nodes can communicate across said network forming, at a logic level, controllers of complexity higher with said composite controllers perform like said network node.
